(19) United States
(12) Patent Application Publication
(10) Pub. No.: US 2023/0130334 A1
(43) Pub. Date: Apr. 27, 2023

(54) Sampling Devices

(71) Applicant: VIRIDIAN CONSULTANTS LIMITED, Dorking Surrey (GB)

(72) Inventor: John WILLIAMS, Dorking Surrey (GB)

(73) Assignee: VIRIDIAN CONSULTANTS LIMITED, Dorking Surrey (GB)

(21) Appl. No.: 17/913,984

(22) PCT Filed: Mar. 24, 2021
(86) PCT No.: PCT/GB2021/050713

§ 371 Date: Sep. 23, 2022

(30) Foreign Application Priority Data
Mar. 24, 2020 (GB) 2004251.1

(51) Int. Cl. G01N 1/44; G01N 1/08; G01N 23/20008

(52) U.S. Cl. CPC G01N 1/44; G01N 1/08; G01N 23/20008; G01N 2001/028

(57) ABSTRACT

A sampling device for obtaining a material sample from a surface is provided. The sampling device comprises a housing (4) defining a cavity (6) for forming an at least semi-enclosed space adjacent a surface; an extraction conduit in communication with the cavity for extracting a material sample from the surface; an input interface arranged to receive light from a first direction (A); and an optical subsystem. The optical subsystem is located at least partially within the housing and is arranged to direct light from the input interface to be output through the cavity in a second direction that is substantially perpendicular to the first direction (A), to ablate a material sample from the surface.

The present invention relates to a device for obtaining a material sample from a surface.

Radiological characterisation (i.e. determining the presence and nature of radioactive materials) is an important process to carry out during operation and decommissioning of nuclear facilities (e.g. nuclear power stations). Surfaces within nuclear facilities, such as walls or floors, can become contaminated with radioactive material over the lifetime of the facility and it is important to understand the presence, degree and type of this contamination. For example, information about the degree and type of contamination present is necessary during decommissioning operations to ensure contaminated material is properly handled, stored and/or disposed of (e.g. as high-level or low-level radioactive waste). It is similarly useful to analyse surfaces comprising other hazardous materials, such as asbestos.

Characterising surface contamination typically involves obtaining a sample of the potentially contaminated surface and then analysing this sample in a laboratory (e.g. using a mass spectrometer to identify particular elements and isotopes in the samples). Current methods of obtaining samples involve a worker mechanically separating material from the surface (e.g. using a hammer, chisel or drill) and collecting a sample from the debris. The collected sample is then sent for analysis (e.g. at an off-site laboratory). However, this process is slow and is only suitable for sampling surfaces that are accessible to workers, requiring the erection of scaffolds to reach the upper regions of walls, and being completely unsuitable for sampling in confined spaces. Furthermore, using crude mechanical processes to produce samples may result in a significant amount of material being collected from a deeper location away from the surface, where the level of contamination may be lower. This can dilute the calculated level of contamination, reducing accuracy. Some similar problems are also encountered when sampling surfaces comprising other hazardous materials such as asbestos.

It has been proposed to use photo-ablation (e.g. laser ablation) to collect samples from a contaminated or otherwise hazardous surface. Laser ablation techniques involve focusing a high power laser onto the surface to be sampled to ablate material from the surface as a powder. This is then collected (e.g. extracted under vacuum) for analysis. However, current laser ablation surface sampling devices are unsuited to many sampling situations and an improved approach may be desired.

According to a first aspect of the present invention there is provided a sampling device for obtaining a material sample from a surface, the sampling device comprising:
a housing defining a cavity for forming an at least semi-enclosed space adjacent a surface;
an extraction conduit in communication with the cavity for extracting a material sample from the surface;
an input interface arranged to receive light from a first direction; and
an optical subsystem located at least partially within the housing and arranged to direct light from the input interface to be output through the cavity in a second direction that is substantially perpendicular to the first direction, to ablate a material sample from the surface.

The invention extends to a sampling system comprising:
a light source;
an extraction subsystem; and
the sampling device as disclosed herein, wherein the light source is arranged to deliver light to the input interface, and the extraction subsystem is arranged to extract a material sample of a surface adjacent the sampling device via the extraction conduit.

From a second aspect of the present invention there is provided a method of obtaining a material sample from a surface comprising:
providing light in a first direction to an input interface of a sampling device;
directing light from the input interface towards a surface in a second direction that is perpendicular to the first direction and normal to the surface;
ablating the surface with the light to produce a sample; and
extracting the sample from the surface.

It will be appreciated by those skilled in the art that receiving light in a first direction and outputting it from the cavity onto the surface in a second, perpendicular direction facilitates the sampling of surfaces in confined locations such as the inside of pipes, because there does not need to be space above the surface (i.e. in the second direction) to accommodate hardware (e.g. an optical fibre) providing light to the input interface. The size of the sampling device itself in the second direction may also be reduced because the input interface and/or elements of the optical subsystem (which may comprise parts or components with an inherent length in the direction from which light is received) are oriented with reference to the first direction rather than an in-line set up in which input light is received in-line with (i.e. in the same direction as) output light.

It will also be appreciated that the present invention may be particularly useful for sampling surfaces that are potentially contaminated with radioactive material, or for surfaces comprising other hazardous materials (e.g. asbestos), because the optical subsystem of the present invention is located at least partially within the housing. When sampling potentially contaminated or hazardous surfaces, great care has to be taken to avoid retaining contaminated or hazardous (e.g.. radioactive, toxic or carcinogenic) material on the sampling device itself, both for safety reasons but also to corrupting later samples taken by the same device (e.g. of a different surface that may not be contaminated or hazardous). This issue may be mitigated by simply disposing of the whole device after only one use. However, doing this multiple times (i.e. for multiple samples) this produces a lot of waste (which may itself need to be disposed of as radioactive or otherwise hazardous waste) and it may be expensive and time-consuming to replace the disposed device. However, because the optical subsystem of the present invention is located at least partially within the housing, it may therefore be protected from contact with contaminated/hazardous surfaces/environments, reducing the likelihood of the optical subsystem itself becoming contaminated/hazardous during use. In some embodiments, the optical subsystem is removable from the housing. In such embodiments, the housing may be disposed of (e.g. after every use or a set number of uses), whilst the optical subsystem can be reused (i.e. with a new housing) without sacrificing safety or accuracy. The optical subsystem may represent a significant proportion of the costs of the device, so being able to reuse it may significantly reduce the costs of sampling. The input interface may be removable from the housing (e.g. with the optical subsystem).

Preferably the optical subsystem is entirely enclosed by the housing, to more completely isolate the optical subsystem from the environment surrounding the device and reduce the likelihood of any contamination of the optical subsystem. In some such embodiments the housing comprises a window (e.g. comprising glass or another material transparent to the wavelength(s) of the light used) which at least partially defines the cavity and through which the optical subsystem is arranged to direct light in the second direction. A window allows transmission of the laser light from the optical subsystem into the cavity (and thus onto the surface adjacent the cavity) whilst helping to isolate the optical subsystem from the ablated (and potentially radioactive or otherwise hazardous) material sample.

In a preferred set of embodiments, the device comprises a height along an axis parallel to the second direction of 6 inches (i.e. approximately 15 cm) or less. This may enable the unit to be used in a standard 6 inch diameter pipe, which are often found in nuclear facilities.

Conventionally, photo-ablation techniques avoid changes in the direction of input light to reduce optical losses and device complexity. However, the Applicant has recognised that these issues may in some circumstances be acceptable in view of the advantages such redirection provides.

The housing may comprise a polymer, e.g. nylon. The housing may be injection moulded or 3D printed (e.g. using a Selective Laser Sintering process).

In some sets of embodiments, additionally or alternatively, the optical subsystem is arranged to focus the light in a plane adjacent the cavity (i.e. corresponding to the position of a surface to be sampled when the sampling device is in operation).

The optical subsystem may comprise one or more lenses and/or mirrors arranged to focus and direct light received at the input interface. Preferably, the optical subsystem comprises, in the order they are encountered by light received at the input interface and output through the cavity, one or more lenses, one or more mirrors, and one or more further lenses.

In some sets of embodiments, at least part of the extraction conduit passes through the housing, for example extending within the housing from the cavity to an extraction interface (e.g. an aperture). At least part of the extraction conduit may extend in a direction parallel to the first direction. The extraction conduit may be arranged to connect to an extraction subsystem that extends from the sampling device (e.g. from an extracting interface thereof) in a direction parallel to the first direction. As mentioned above, the material sample may be extracted under vacuum (i.e. using a vacuum pump). The extraction conduit may be suitable for vacuum extraction.

In some sets of embodiments the input interface and the extraction interface are formed in or located adjacent to an interface side of the housing. The interface side may extend at least partially in a plane perpendicular to the first direction (e.g. comprising a planar surface extending entirely in a plane perpendicular to the first direction or comprising a curved surface with a tangent plane perpendicular to the first direction).

In some sets of embodiments, the cavity is provided in a sampling side of the housing that is arranged to be put in contact with a surface to be sampled. In other words, the cavity comprises an opening in the sampling side such that, when the sampling side of the housing is put in contact with the surface an at least semi-enclosed space is formed. Preferably, at least part of the sampling side (and preferably a part of the sampling side on which the cavity is provided) is perpendicular to the second direction (e.g. comprising a planar surface extending entirely in a plane perpendicular to the second direction or comprising a curved surface with a tangent plane perpendicular to the second direction). This may help to align the second direction (in which the light is output through the cavity) to be normal to the surface to be sampled. This may maximise the intensity of light on the sample, expediting ablation.

Preferably, the sampling side comprises a shape corresponding to that of an intended surface to be sampled (e.g. comprising a matching or complementary shape). This may improve how well enclosed the space formed by the cavity adjacent the surface is, thus improving the efficacy of the extraction conduit and extraction subsystem when extracting a sample from the surface (e.g. speeding up extraction and/or maximising the amount of sample that is extracted).

For example, a device for sampling a flat wall may have a sampling side comprising a planar surface. A device for sampling a curved surface (e.g. a pipe) may have a sampling side comprising a correspondingly curved surface. The sampling side may comprise a convex surface (e.g. for sampling an internal wall of a cylindrical pipe) or a concave surface (e.g. for sampling an external wall of a cylindrical pipe).

Preferably, the sampling side has a cross section in a plane perpendicular to the first direction that comprises an arc with a radius of curvature of approximately 3 inches or 75 mm (i.e. to match a 6 inch or 150 mm diameter pipe).

In some sets of embodiments, additionally or alternatively, the sampling device comprises at least one proximity sensor arranged to sense proximity of the sampling device to a surface to be sampled (e.g. the proximity of a sampling side to a surface to be sampled). This may help to ensure that the sampling device is sufficiently close to a surface to achieve effective photo-ablation of the surface and/or effective extraction of the ablated sample. A proximity sensor may also be used to provide a safety interlock function, which automatically prevents light being output through the cavity unless the device is sufficiently close to the surface.

The sampling device may comprise a plurality of proximity sensors. The proximity sensors may be arranged to sense the proximity of different points of the sampling device to the surface to be sampled. For instance, the sampling device may comprise a plurality of proximity sensors each arranged to sense proximity of a different point of a sampling side to a surface to be sampled. By sensing the proximity of different points of a sampling side to the surface to be sampled, it may be possible to sense not only the proximity of the sampling device to the sampling surface but also the orientation of the sampling device relative to the sampling surface. This may be particularly useful when the sampling device is used in difficult-to-access regions (e.g. the inside of pipes) as the system/a user can tell when the sampling device is in a good position for sampling even if the sampling device is not visible to the user. For instance, this may help to ensure that the second direction is normal to the surface to be sampled and that the light output through the cavity is normally incident on the surface to be sampled, thus maximising the intensity of light incident of the surface, increasing the speed and/or effectiveness of ablation. This may also help to ensure that the cavity is not tilted away from the surface to sampled and thus less able to extract the sample from the surface,

Useful information on the orientation of the sampling device (e.g. about one axis) may be obtained with only two proximity sensors but in some preferred examples the sampling device three or more proximity sensors, e.g. four proximity sensors. The sampling device may comprise two proximity sensors located on a first axis running parallel to the first direction, and two proximity sensors located on a second axis running perpendicular to the first direction and the second direction.

The proximity sensor(s) may comprise any sensor suitable for sensing a proximity to a surface, such as infrared sensors or ultrasound sensors. In embodiments comprising a plurality of proximity sensors, two or more different types of proximity sensors may be used. In a preferred set of embodiments, the proximity sensor(s) comprises a capacitive proximity sensor. In such embodiments the proximity sensor(s) may be at least partially enclosed by the housing and still provide accurate proximity information as they can sense “through” the housing. This means they may be protected from the environment surrounding the housing (which may contain radioactive or otherwise hazardous materials, e.g. asbestos). The proximity sensor(s) may be removable from the housing (e.g. to allow disposal of a potentially contaminated housing). In some sets of embodiments, both the proximity sensor(s) and the optical subsystem are removable from the housing. In some such embodiments the proximity sensor(s) and the optical subsystem may both be mounted in or to a common removable frame or cartridge that facilitates the removal of both components in a single step (e.g. along with their subsequent installation in a fresh housing). Mounting the optical subsystem and the proximity sensor(s) in or to a common removable frame or cartridge also ensures their relative positions and/or orientations are correct when they are installed in a new housing. The input interface may also be mounted on or to the common removable frame or cartridge.

The proximity sensor(s) may be arranged to output a monotonically varying measure of the distance to the surface to be sampled (e.g. a voltage). Alternatively, the proximity sensor(s) may be arranged to output a binary indication of whether a predetermined proximity condition is met (e.g. the proximity sensor(s) may comprise one or more relays arranged to output a first voltage when a predetermined proximity condition is met and a second voltage when the predetermined proximity condition is not met).

The sampling device may be arranged to automatically prevent operation (i.e. to prevent light being output through the cavity) if the proximity of the sampling device to a surface to be sampled and/or orientation of the sampling device sensed by proximity sensor(s) does not meet a predetermined criterion (e.g. when the sampling device is more than predetermined distance from the surface to be sampled, or when the sampling device is oriented such that the second direction is not sufficiently close to normal to the surface to be sampled).

Additionally or alternatively, the sampling device may be arranged to output (i.e. to another device of the sampling system) a signal containing information on the proximity of the sampling device to a surface to be sampled and/or the orientation of the sampling device relative to the surface to be sampled. The signal may comprise a plurality of components each corresponding to an output from a different proximity sensor (e.g. each component simply comprising the output from a proximity sensor). Alternatively, the signal may comprise one or more components derived from the outputs of one or more proximity sensors (e.g. a determined average proximity, pitch, roll and/or yaw of the sampling device).

The sampling device may be arranged to output the signal to the light source or a separate control device arranged to prevent operation (e.g. to shut off the light source) if a proximity and/or orientation criterion is not met. Additionally or alternatively, the sampling system may comprise an indicator device arranged to receive the signal and provide an indication of the proximity and/or orientation to a user. The indicator device may comprise one or more indicator lights (e.g. coloured LEDs) arranged to display information relating to proximity and/or orientation visually. In one preferred set of embodiments the indicator device comprises a series of indicators (e.g. red/green LEDs) each corresponding to a proximity sensor on the sampling device and arranged to indicate when a predetermined proximity condition is met for each proximity sensor. In such examples, a user may know only to operate the sampling device when all indicators show a positive proximity indication (i.e. when the sampling device is in a good position for sampling).

The sampling device may comprise a wireless transmitter (e.g. arranged to operate according to the Bluetooth™ or Wi-Fi™ standards) arranged to output the signal containing information on the proximity and/or the orientation of the sampling device relative to the surface to be sampled. However, in some preferred embodiments the sampling device comprises a data interface arranged to output the signal to a data cable (e.g. an RJ45 socket). A wired connection may be more robust than a wireless connection, which may be important in nuclear facilities. In some embodiments in which the proximity sensor(s) are removable from the housing, the data interface (and/or, in relevant embodiments, the wireless transmitter) may also be removable from the housing (e.g. mounted on a common removable frame or cartridge with the optical subsystem, the proximity sensors and the input interface).

The sampling device may be arranged to be positioned manually by a user (e.g. by a user handling the device directly or via a handling device such as a rigid pole to which the sampling device is attached). Additionally or alternatively, the sampling device may be arranged to be positioned by a robot, e.g. a semi-autonomous robot. The sampling device may comprise one or more mounting structures for mounting or coupling the sampling device to another device (e.g. a handling device or a robot). The mounting structures may be part of the housing. The mounting structures may comprise pivot pins. The mounting structures may be located at a position aligned with the centre of gravity of the device.

In embodiments in which the device is arranged to be positioned by a robot, information from the proximity sensor(s) may be fed back to the robot to refine its positioning automatically.

The light source preferably comprises a laser, e.g. an infrared laser, which may be particularly suitable for transmission via optical fibres and for ablation of many different materials. The sampling device may be suitable for sampling surfaces comprising many different materials including concrete, steel or graphite.

The extraction subsystem preferably comprises a pump (e.g. a vacuum pump) arranged to draw air and material samples from the cavity through the extraction conduit. The extraction subsystem may comprise a sample container arranged to retain an extracted sample. The sample container may be removable from the extraction subsystem.

In some sets of embodiments, the sampling system comprises an optical fibre arranged to deliver light from the light source to the input interface. The input interface is preferably arranged to allow an optical fibre to be removably coupled to the sampling device. For example, the input interface may comprise a bayonet-type coupler. This may facilitate replacement of the sampling device (or just a housing thereof) between the taking of different samples.

In some sets of embodiments, additionally or alternatively, the extraction subsystem comprises a flexible extraction tube (e.g. a nylon tube) connected to the extraction conduit of the sampling device. The flexible extraction tube may extend from the extraction conduit parallel to the first direction. The extraction tube may be arranged to connect the extraction conduit with a pump and/or a sample container. The extraction tube may be of any length (e.g. from 1 m or less to 40 m or more), but preferably allows some separation between the sampling device and the rest of the sampling system (e.g. to mitigate contamination of parts of the sampling system). For example, the extraction tube may be at least 10 m long, and may be at least 15 m long, e.g. 20 m, 30 m or even 40 m or longer.

As mentioned above, avoiding the contamination of components of the sampling device (e.g. the optical subsystem) with potentially radioactive or otherwise hazardous material from the environment surrounding the sampling device may allow these components to be re-used for multiple different samples. The light source and extraction subsystem are preferably located sufficiently far (e.g. tens of metres) from the sampling device during use to avoid contamination, but an optical fibre or a data cable connected to an input or data interface of the sampling device may be susceptible to contamination (e.g. at or near the input interface).

Thus, in some sets of embodiments, the sampling system comprises flexible tubing arranged to isolate the input interface and at least a portion of the optical fibre from an environment surrounding the sampling device. In those embodiments in which the sampling device comprises a data interface arranged to output the signal to a data cable, the flexible tubing may, additionally or alternatively, be arranged to isolate the data interface and at least a portion of the data cable from an environment surrounding the sampling device.

For example, the sampling system may comprise flexible tubing (e.g. lay-flat tubing) extending from the input interface and/or the data interface and enclosing (and thus isolating) the input interface and/or the data interface and at least a portion of the optical fibre and/or the data cable. The housing may comprise a protruding shroud around the input interface and/or the data interface from which the flexible tubing extends. The flexible tubing may be sufficiently large to allow the optical fibre and/or the data cable to travel within the flexible tubing. This may allow the optical fibre and/or the data cable to be coupled and uncoupled from the input interface and/or the data interface whilst the isolating flexible tubing remains in place. The optical fibre and/or the data cable can thus be connected to or disconnected from the sampling device without needing to take the sampling device into a safe (i.e. non-contaminated) environment.

The method of obtaining a material sample from a surface may thus further comprise isolating the input interface and at least a portion of an optical fibre from an environment surrounding the sampling device using flexible tubing; and then coupling the isolated optical fibre to the input interface of the sampling device.

In some embodiments, coupling the optical fibre to the input interface may comprise manipulating the optical fibre (e.g. rotating a bayonet fitting of the optical fibre into a corresponding bayonet fitting of the input interface) through (i.e. from the outside of) the flexible tubing. In some embodiments, the sensing system may comprise a manipulation device (e.g. an oversized spanner tool) coupled to the optical fibre and arranged to facilitate manipulation of the optical fibre through the flexible tubing. The manipulation tool may be moveable relative to the optical fibre (e.g. it may be free to move along and/or rotate around the optical fibre). For example, the manipulation tool may be moveable relative to the optical fibre when it is not being used to manipulate the optical fibre or parts thereof (e.g. a bayonet fitting).

This may aid the coupling of the optical fibre to the input interface without breaking the isolation of the optical fibre. For example, it may be difficult to achieve from the outside of the flexible tubing a 90 degree rotation of the optical fibre or a bayonet fitting thereof necessary to couple the optical fibre to the input interface. In embodiments wherein the housing comprises a protruding shroud around the input interface and/or the data interface, this may also obscure access to the input interface and/or data interface, making coupling more difficult. A protruding shroud may, for example, obstruct access to a bayonet fitting of an optical fibre.

However, an oversized spanner tool coupled to the optical fibre (i.e. also located within the flexible tubing) may be far easier to grasp and manipulate through the flexible tubing than the optical fibre (or a standard bayonet fitting thereof) itself. This may be particularly useful when the device is used during nuclear decommissioning, during which operators are generally required to wear several pairs of gloves. Thus, in some embodiments coupling the optical fibre to the input interface (or decoupling the optical fibre from the input interface) comprises manipulating through the flexible tubing a manipulation device coupled to the optical fibre. This may comprise rotating the manipulation device to couple the optical fibre to the input interface.

The Applicant believes these features of the method to be independently inventive and thus the invention extends to a method of coupling an optical fibre to an input interface of a sampling device arranged to obtain a material sample from a surface, the method comprising:
isolating the input interface and at least a portion of the optical fibre from an environment surrounding the sampling device using flexible tubing; and
coupling the isolated optical fibre to the input interface of the sampling device by manipulating the optical fibre through the flexible tubing.

In some embodiments, manipulating the optical fibre comprises manipulating through the flexible tubing a manipulation device coupled to the optical fibre and located within the flexible tubing. Manipulating the optical fibre may comprise rotating the manipulation device to couple the optical fibre to the input interface.

Features of any aspect or embodiment described herein may, wherever appropriate, be applied to any other aspect or embodiment described herein. Where reference is made to different embodiments, it should be understood that these are not necessarily distinct but may overlap. It will be appreciated that all of the preferred features of the sampling device and sampling system according to the first aspect described above may also apply to the other aspects of the invention.

One non-limiting embodiment will now be described, by way of example only, and with reference to the accompanying figures in which:

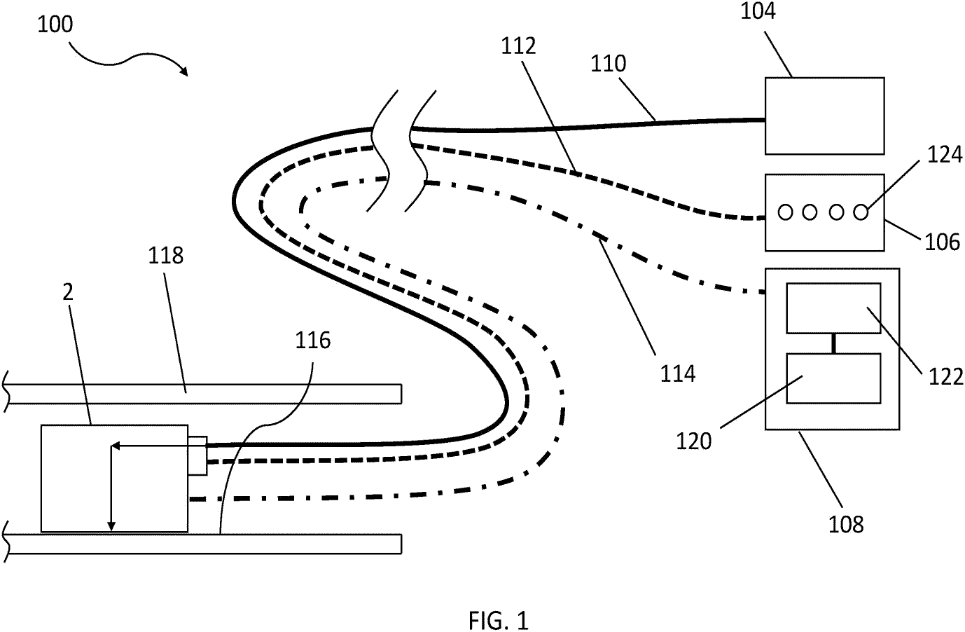

FIG. 1 is a schematic view of a sampling system according to an embodiment of the invention;

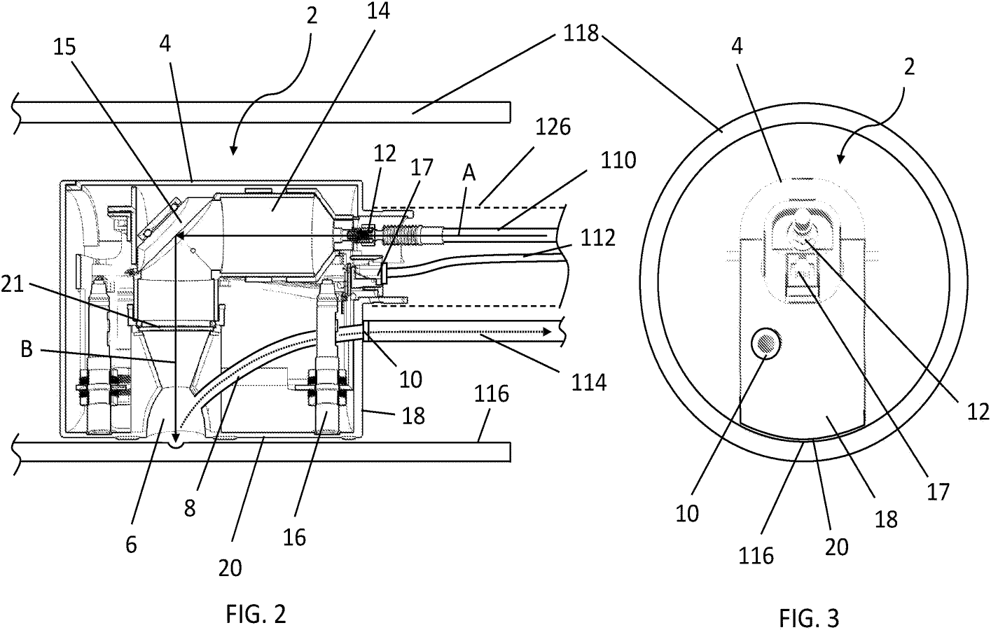

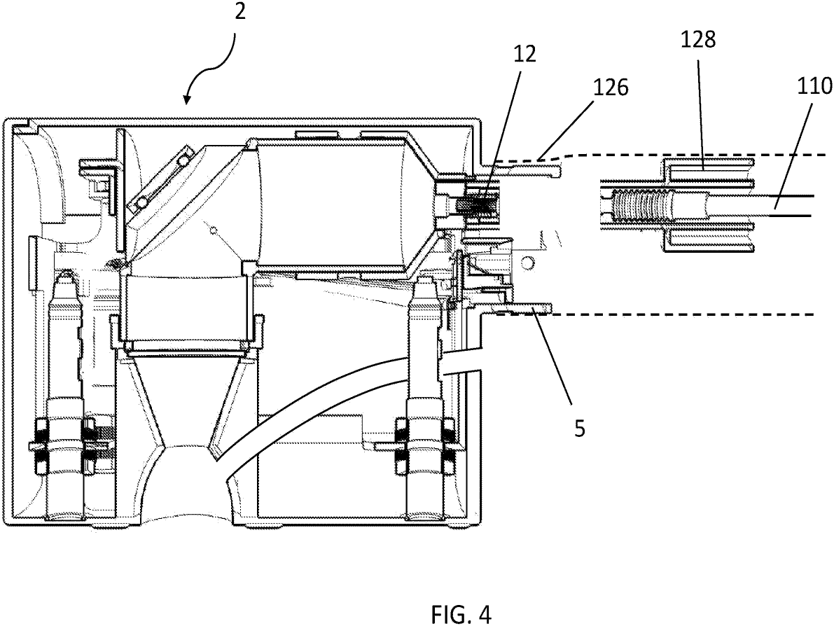

FIGS. 2 and 3 show the sampling device of the system of FIG. 1 in more detail;

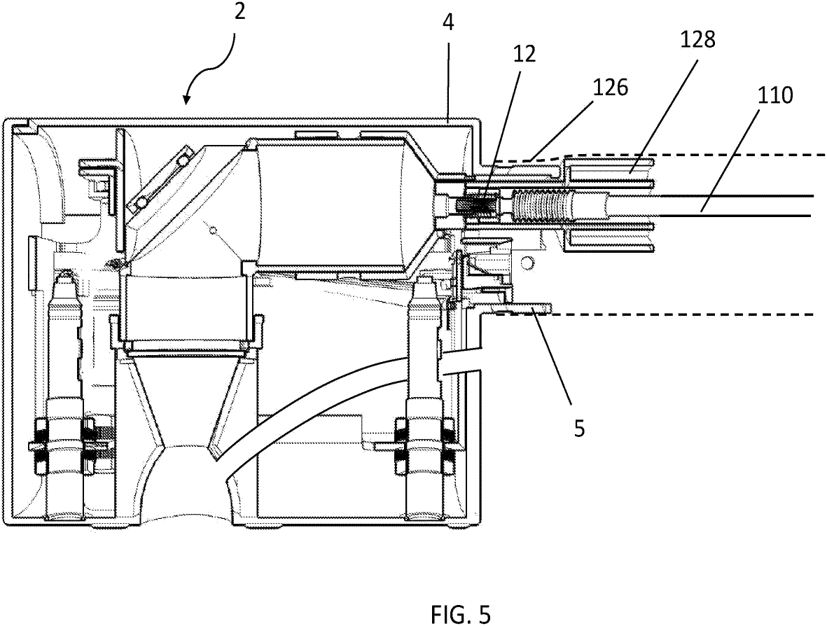

FIGS. 4 and 5 illustrate a method of coupling an optical fibre to a sampling device; and

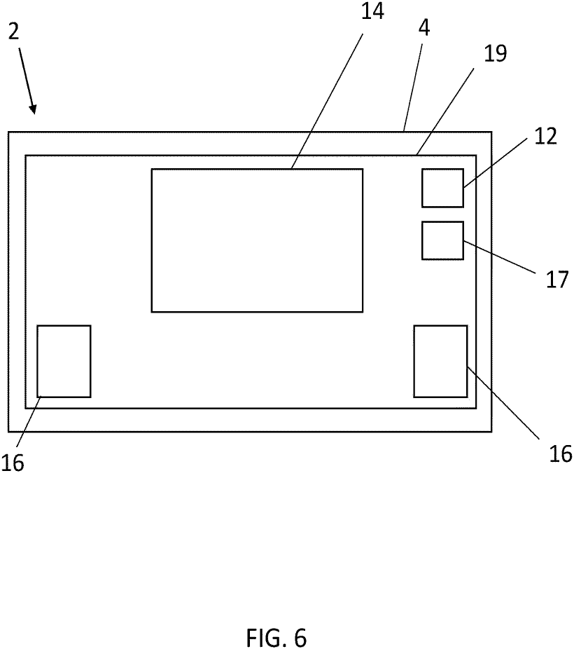

FIG. 6 is a schematic view of the sampling device of the system of FIG. 1.

FIG. 1 shows a sampling system 100 according to an embodiment of the invention. The sampling system 100 comprises a sampling device 2 (described in more detail below with reference to FIGS. 2 and 3), a light source 104 (e.g. an IR laser), an indicator device 106 and an extraction subsystem 108. The light source 104 is connected to the sampling device 2 via an optical fibre 110. The indicator device 106 is connected to the sampling device 2 via a data cable 112. The extraction subsystem 108 is connected to the sampling device via an extraction tube 114.

The extraction subsystem 108 comprises a pump 120 and a sample container 122. When operational, the pump 120 creates a region of low pressure in the sample container that draws air from the extraction tube 114 into the sample container 122. In use, the light source 104, indicator device 106 and extraction subsystem 108 may be positioned away from the sampling device 2 (e.g., positioned approximately 15 m away from the sampling device 2), to mitigate contamination of the light source 104, the indicator device 106 or the extraction subsystem 108..

The sampling system 2 is arranged to obtain a material sample of a surface to be sampled 116, which in this case comprises the inner wall of a six-inch (approximately 150 mm) diameter pipe 118.

The indicator device 106 comprises four red/green LEDs 124. As explained in more detail below, the colour of the LEDs 124 may indicate to a user of the system 100 when the sampling device 2 is in the correct position and orientation to take a sample of the surface 116.

The sampling device 2 (as shown in more detail in FIGS. 2 and 3) comprises a housing 4 defining a cavity 6 on a sampling side thereof, an extraction conduit 8 extending from the cavity 6 to an extraction interface 10, an input interface 12, an optical subsystem 14 and a plurality of proximity sensors 16 (e.g. capacitive proximity sensors) connected to a data interface 17 (e.g. an RJ45 socket).

The housing 4 comprises an interface side 18 on which the input interface 12 and the extraction interface 10 are located, and a sampling side 20 in which the cavity 6 is provided. The housing 4 comprises a window 21 that partially defines the cavity 6 and separates the optical subsystem 14 from the cavity 6. The window 21, together with the rest of the housing 4 entirely encloses the optical subsystem 14 and isolates it from the environment surrounding the sampling device 2.

The input interface 12 and the data interface 17, along with at least part of the optical fibre 110 and the data cable 112 are enclosed by flexible tubing 126 (e.g. lay-flat tubing) that extends from the interface side 18 of the housing 4

The optical fibre 110 is coupled to the input interface 12 to provide light from the light source 104 into the sampling device 2 from a first direction A. The optical subsystem 14 comprises a mirror 15 and one or more lenses (not shown) which direct the light from the input interface 12 to be output through the cavity 6 in a second direction B that is perpendicular to the first direction A. The optical subsystem 14 is arranged to focus the light onto the surface 116 to ablate a material sample from the surface 116.

In use, the sampling device 2 is positioned with the sampling side 20 adjacent the surface to be sampled 116 (i.e. the interior wall of the pipe 118), such that the cavity 6 and the surface 116 form an enclosed space. FIG. 3 shows how the sampling side 20 comprises a convex curved surface that matches the curve of the pipe wall 116. This means that when the sampling device 2 is properly orientated (as shown in FIGS. 2 and 3), the space adjacent the surface 116 formed by the cavity 6 is effectively enclosed and the second direction B is normal to the surface 116.

The extraction tube 114 is connected to the extraction interface 10 of the sampling device, such that when the vacuum pump 120 is operational, the ablated material sample is drawn from the surface 116, through the extraction conduit 8, along the extraction tube 114 and into the sample container 122, where it is retained.

The proximity sensors 16 are arranged to sense the proximity of points on the sampling side 20 of the housing 4 to the surface 116. The proximity sensors 16 output the sensed proximities via the data interface 17. The data cable 112 is connected to the data interface 17. Each LED 124 of the indicator device 106 corresponds to a different proximity sensor 16. When a proximity measured by a proximity sensor 16 and output to the indicator device 106 via the data cable 112 is less than a predetermined threshold (e.g. less than 2 mm), the corresponding LED 124 turns green. When a proximity is greater than the threshold, the corresponding LED 124 turns red. Thus, when all the LEDs 124 are green, the user of the sampling system 100 can be confident that the sampling device 2 is in the optimal orientation to take a sample (i.e. flush against the surface 116 with the direction B normal to the surface 116). The sampling device 2 may also be arranged to prevent automatically light being output through the cavity 6 unless the proximity sensors 16 indicate that the sampling device 2 is in an acceptable position/orientation (i.e. performing a safety interlock function).

As shown schematically in FIG. 6, the sampling device 2 comprises a removable cartridge 19 to which the optical subsystem 14, the input interface 12, the proximity sensors 16 and the data interface 17 are mounted. The cartridge 19 and the components mounted thereto are removable from the housing 4, to allow the housing 4 to be replaced quickly and easily (e.g. where the housing 4 may have been contaminated through contact with the surface 116). A user may remove the cartridge 19 (along with the components attached thereto) from the housing 4 in a single step, and subsequently install them into a new (e.g. uncontaminated) housing. This allows a user to conveniently re-use multiple components of the sampling device 2 (e.g. more expensive components) several times in different housings.

FIGS. 4 and 5 illustrate a method for coupling the optical fibre 110 to the sampling device 2. The flexible tubing 126 is positioned over the input interface 12 to isolate it from the environment surrounding the sampling device 2. The flexible tubing 126 extends from a protruding shroud 5 of the housing 4. Either before or after this, the optical fibre 110 is introduced into the flexible tubing at a point away from the sampling device 2 (i.e. away from any potential contaminated material).

The optical fibre 110 is then pushed along the flexible tubing 126 towards the sampling device 2. The flexible tubing 126 isolates the input interface 12 and at least a portion of the optical fibre 110 from the environment surrounding the sampling device throughout this process.

As shown in FIG. 5, the optical fibre 110 is then manipulated by a user, from the outside of the flexible tubing 126, to couple the optical fibre 110 to the input interface 12. A manipulation tool 128 may be coupled to the optical fibre 110 to aid this. The manipulation tool 128 comprises an oversized spanner tool that makes manipulating the optical fibre 110 through the flexible tubing 126 easier. For instance, a user may have to rotate the optical fibre 110 or an end fitting thereof through 90 degrees to couple it to the input interface 12 (e.g. to engage a bayonet fitting) and it may be easier to rotate the larger manipulation tool 128 than the small optical fibre 110 through the flexible tubing 126. The manipulation tool 128 may also facilitate the manipulation of parts of the optical fibre 110 (e.g. a bayonet fitting thereof) that are obscured within the protruding shroud 5 of the housing 4. The manipulation tool 128 may be moveable relative to the optical fibre 110 (e.g. it may be free to move along and/or rotate around the optical fibre 110, for instance when it is not being used to manipulate parts of the optical fibre 110).

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims. As mentioned above, the sampling device may be used for obtaining samples from various different materials, including asbestos-containing materials. radioactive materials, and other potentially hazardous materials, even though different material samples may subsequently be analysed differently.

1. A sampling device for obtaining a material sample from a surface, the sampling device comprising:
a housing defining a cavity for forming an at least semi-enclosed space adjacent a surface;
an extraction conduit in communication with the cavity for extracting a material sample from the surface;
an input interface arranged to receive light from a first direction; and
an optical subsystem located at least partially within the housing and arranged to direct light from the input interface to be output through the cavity in a second direction that is substantially perpendicular to the first direction, to ablate a material sample from the surface.

2. A sampling device as claimed in claim 1, wherein the optical subsystem is removable from the housing.

3. (canceled)

4. A sampling device as claimed in claim 1, wherein the housing comprises a window which at least partially defines the cavity and through which the optical subsystem is arranged to direct light in the second direction.

5. (canceled)

6. A sampling device as claimed in claim 1, wherein the extraction conduit is arranged to connect to an extraction subsystem that extends from the sampling device in a direction parallel to the first direction.

7. A sampling device as claimed in claim 1, wherein the cavity is provided in a sampling side of the housing that is arranged to be put in contact with a surface to be sampled.

8. (canceled)

9. (canceled)

10. (canceled)

11. A sampling device as claimed in claim 7, wherein the sampling side comprises a curved surface.

12. A sampling device as claimed in claim 1, comprising at least one proximity sensor arranged to sense the a proximity of the sampling device to a surface to be sampled.

13. (canceled)

14. A sampling device as claimed in claim 12, wherein the proximity sensor(s) is at least partially enclosed by the housing.

15. A sampling device as claimed in claim 14, wherein the proximity sensor(s) is removable from the housing.

16. A sampling device as claimed in claim 15, wherein the proximity sensor(s) and the optical subsystem are mounted in or to a common removable frame or cartridge.

17. A sampling device as claimed in claim 12, wherein the sampling device is arranged to output a signal containing information on the proximity of the sampling device to a surface to be sampled or the an orientation of the sampling device relative to the surface to be sampled.

18. (canceled)

19. (canceled)

20. A sampling device as claimed in claim 1, comprising a height along an axis parallel to the second direction of six inches (i.e. approximately 15 cm) or less.

21. A sampling system comprising:
a light source;
an extraction subsystem; and
a sampling device as claimed claim 1, wherein the light source is arranged to deliver light to the input interface, and the extraction subsystem is arranged to extract a material sample of a surface adjacent the sampling device via the extraction conduit.

22. (canceled)

23. (canceled)

24. A sampling system as claimed in claim 21, comprising an optical fibre coupled to the input interface and arranged to deliver light from the light source to the input interface.

25. A sampling system as claimed in claim 21, wherein the extraction subsystem comprises a flexible extraction tube connected to the extraction conduit of the sampling device, the extraction tube extending from the extraction conduit parallel to the first direction.

26. (canceled)

27. A sampling system as claimed in claim 24 to 26, comprising flexible tubing arranged to isolate the input interface and at least a portion of the optical fibre from an environment surrounding the sampling device.

28. A sampling system as claimed in claim 27, comprising a manipulation device coupled to the optical fibre and arranged to facilitate manipulation of the optical fibre through the flexible tubing.

29. A method of obtaining a material sample from a surface comprising:
providing light in a first direction to an input interface of a sampling device;
directing light from the input interface towards a surface in a second direction that is perpendicular to the first direction and normal to the surface;
ablating the surface with the light to produce a sample; and
extracting the sample from the surface.

30. A method of obtaining a material sample from a surface as claimed in claim 29, comprising isolating the input interface and at least a portion of an optical fibre from an environment surrounding the sampling device using flexible tubing; and then coupling the isolated optical fibre to the input interface of the sampling device.

31. A method of obtaining a material sample from a surface as claimed in claim 30, wherein coupling the isolated optical fibre to the input interface comprises manipulating the optical fibre through the flexible tubing.

32. (canceled)
